(19) United States
(12) Patent Application Publication
(10) Pub. No.: US 2020/0365036 A1
(43) Pub. Date: Nov. 19, 2020

(54) Interactive Artificial Intelligence System with Adaptive Timing

(71) Applicant: US Govt as represented by Secretary of Air Force, Wright-Patterson AFB, OH (US)

(72) Inventors: David Canzonetta, Dayton, OH (US); Michael Schneider, Clayton, OH (US); Michael Miller, Xenia, OH (US)

(21) Appl. No.: 16/872,727

(22) Filed: May 12, 2020

Related U.S. Application Data
(60) Provisional application No. 62/848,871, filed on May 16, 2019.

(51) Int. Cl. G08G 5/00; H04L 29/06; B64D 45/00

(52) U.S. Cl. CPC G08G 5/0008; B64D 45/0015; H04L 63/1441; G08G 5/0021

(57) ABSTRACT

A method, threat monitoring system, and computer program product provide a human-automation collaborative response. An automated controller monitors an assigned target area using target sensor(s). Categorization status is tracked for targets within the assigned target area. Display(s) of an operator station presents one or more targets being tracked by the automated controller within the assigned target area. The automated controller annotates the one or more targets on the display(s) with an indication of classification status. In response to a previously receiving a previously untracked target from the sensor(s), the automated controller tracks an amount of time that each target has been presented without an operator response to each target via a user interface device. In response to the amount of time that a particular target has been presented without an operator response exceeding a first time threshold, the automated controller responds to the particular target using an automated agent.

### CROSS-REFERENCE TO RELATED APPLICATIONS

This application claims the benefit of priority under 35 U.S.C. § 119(e) to U.S. Provisional Application Ser. No. 62/848,871 entitled “Interactive Artificial Intelligence System with Adaptive Timing” filed 16 May 2019, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to human-automation collaborative user interfaces, and more particular to real-time threat management systems that balance advantages of human and automation detection and identification of threats.

### 2. Description of the Related Art

Tasks related to identifying threats to a network or a facility can be handled collaboratively by an automated agent and a human operator. An automated agent has the ability of speed and scalability; however, some mitigation steps to counter a threat are too important to wholly trust to automation, especially if detection and identification requires synthesizing multiple factors that have a propensity for false positives or false negatives. A human has the ability to make more comprehensive decisions. However, a human is limited by training level, fatigue, and comprehension speed. Augmenting a human with automation is difficult in that the human can begin to rely on the automation too much.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates graphical depiction of an air defense system user interface, according to one or more embodiments;

FIG. 2 illustrates a flow diagram of a method of automation-human collaboration for an air defense system, according to one or more embodiments;

FIG. 3 illustrates a graphical plot indicating the response time of the system as a function of the inter-arrival time as a piece-wise linear function.

FIG. 4 is a graphical depiction of Inter-Arrival Time (IAT) and Agent Response Time (ART) points sampled during the current experiment;

FIG. 5. is a depiction of a space navigator task environment;

FIG. 6 is a graphical depiction of IAT as a function of task time;

FIG. 7 is a graphical depiction of ART as a function of IAT, with linear regions are labeled to indicate the desired functionality of the agent within each region;

FIG. 8 is a graphical depiction of mean sum of normalized human workload as a function of teammate type;

FIG. 9 is a graphical depiction of mean score as a function of the interaction of trial and the teammate order;

FIG. 10 is a graphical depiction of mean number of human draws as a function of experimental trial and teammate type order;

FIG. 11 illustrates the mean percent of maximum score as a function of instruction;

FIG. 12 is a graphical depiction of effect of agent type on the number of human draws per ship. Error bars indicate plus and minus one standard error of the mean;

FIG. 13 is a graphical depiction of percent of maximum possible score as a function of ship IAT and teammate type;

FIG. 14 is a graphical depiction of human draws per ship as a function of inter-arrival time (IAT) and teammate type; and

FIG. 15 presents a flow diagram of a method of human-automation collaborative response, according to one or more embodiments.

### DETAILED DESCRIPTION

According to aspects of the present disclosure, a method, threat monitoring system, and computer program product provide a human-automation collaborative response. An automated controller monitors an assigned target area using target sensor(s). Categorization status is tracked for targets within the assigned target area. Display(s) of an operator station presents one or more targets being tracked by the automated controller within the assigned target area. The automated controller annotates the one or more targets on the display(s) with an indication of classification status. In response to a receiving a previously untracked target from the sensor(s), the automated controller tracks an amount of time that each target has been presented without an operator response to each target via a user interface device. In response to the amount of time that a particular target has been presented without an operator response exceeding a first time threshold, the automated controller responds to the particular target using responses from an automated agent.

In one or more embodiments, the present disclosure provides an interactive system for aiding humans in performing event driven work within a human-agent team. The system includes a signal for determining the rate at which work needs to be performed and an artificial intelligent software agent capable of performing the event driven work. The time that the agent provides the output of its work associated with the event to the operator is dependent upon the signal. In our specific examples, we simulated a system for balancing the workload of an user, the system including an interface representing ships to be routed to planets, a signal representing the rate at which ships appear, an artificial intelligent software agent capable of routing ships to planets where the time the agent routes each ship is a dependent upon the rate at which ships appear. Although the signal represents the rate at which ships appear, it could alternately include other measurable attributes of the task load imposed on the operator including, the current number of open tasks, the skill level of the user, the average time required by the user to respond to an open task, the number or percent of agent actions the human overrides, the phase of a mission, the energy of the user (i.e., fatigue) perhaps detected by observing times user closes eyes, how rapidly they open their eyes, pupil size, the current stress of the user perhaps detected through physiological measures such as heart rate, galvanic skin conductance, heart rate variability, select electroencephalograph (EEG) signals. Although the example includes an interface representing ships to be routed, this is one task example, it could include any entities in a time critical environment, to include air traffic control interfaces, ground or harbor routing interfaces, Unmanned aerial vehicle (UAV) routing interfaces, cyber control systems with events or alerts replacing ships, or any other system employing a user interface wherein humans are teamed with agents to perform tasks which are displayed or represented in the interface. Although not required, the interface should represent work completion as it is completed by both the human and the agent such that the human can perceive the work being completed by the agent.

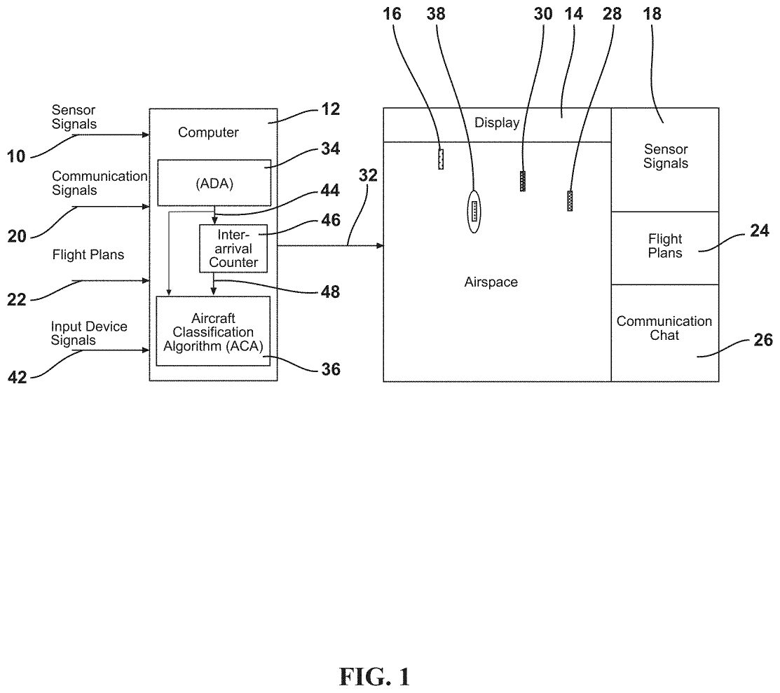

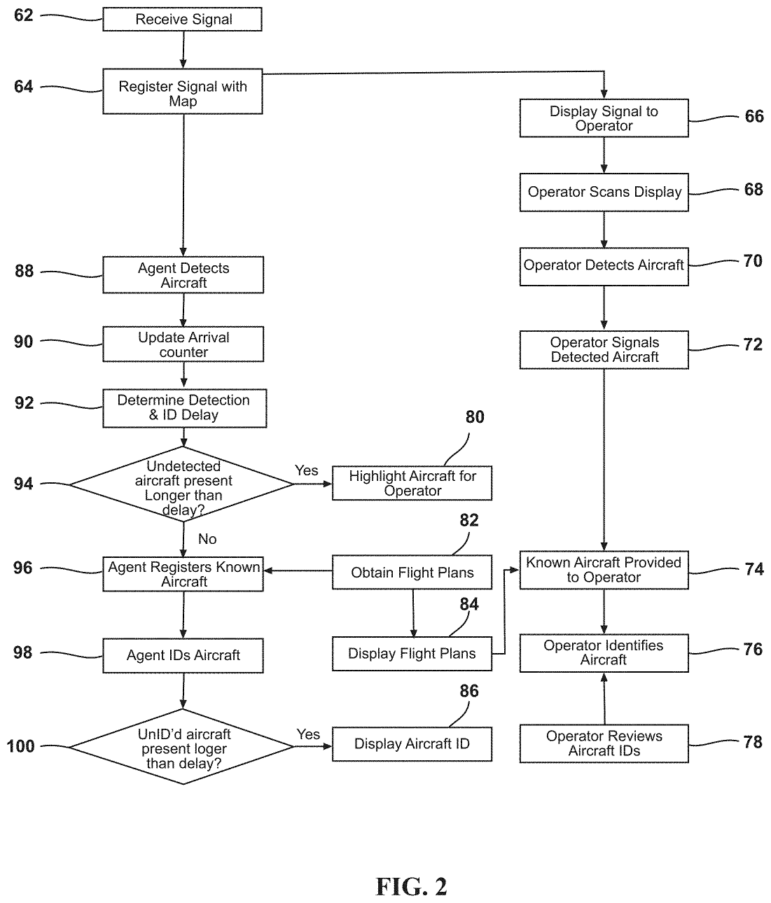

In FIG. 1, in an embodiment of the present invention an air defense system operator is responsible for maintaining watch over a segment of air space by watching sensor input 10 such as radar and other sensor information as it is rendered by a computer 12 onto a display 14. The system is depicted in FIG. 1 and the process performed by this system is depicted in the flow chart of FIG. 2. As an aircraft approaches, the aircraft enters the surrounding airspace and the sensors will provide signals which may correspond to the aircraft location.

Sensor signals 10 corresponding to the location of the aircraft 16 will be received 62 by the computer 12 and typically registered with a map display 64. The resulting image is then displayed 66 on the display 14 on the operator's workstation together with information 18 from each of the available sensors which are capable of sensing the aircraft. The operator is responsible for scanning 68 the information from each of the multiple sensors as it is displayed to detect 70 and to classify or identify 76 the aircraft. For instance, the operator may review the radar information to determine the shape of the aircraft, engines, engine speed or other variables to identify 76 the type of aircraft. Additional information from other sensors, such as thermal energy or other information may be applied to further diagnose the type of aircraft. Finally, other information such as communication signals 20 and flight plans 22 may be obtained 80 by the computer and displayed 84 on designated areas 24, 26 of the display 14 in order to provide 74 the operator with information regarding known aircraft operating in the area. This information can be used to further corroborate aircraft identification through transmission of a display signal 32 to the display. Based upon this information, the operator will identify 76 the type of aircraft and provide an aircraft location and identification using input devices to provide an input device signal 42 to the computer. For example, the operator may indicate whether the aircraft is friendly which will change its representation 28 on the display 14 or foe which will also change its representation 30 on the display, or the aircraft will remain unidentified and further monitored to render a final decision. Note that as the operator detects the aircraft, they can signal 72 the detected aircraft to the system. Similarly, when they identify the aircraft, they signal this identification to the system. Each of these signals are used by the agents to determine whether the operator has detected or identified existing aircraft.

As the operator is only able to provide the identification for a limited number of aircraft, one or more artificial automated software agents may be provided to support the operator. For example, an aircraft detection agent (ADA) 34 might be instantiated in the computer 12 and provided for detecting 88 low signal levels which might be associated with an aircraft. Additionally, an aircraft identification agent (ACA) 36 might be provided to automatically provide an identification 98 of an aircraft. However, these artificial automated software agents will likely be less than 100 percent reliable and cannot be held accountable for making improper detections or identifications. Therefore, it is important that the ADA, the ACA, and the operator function as a team to provide as high a reliability in this function as possible.

Although it might be typical for the automated agents 34, 36 to display detection or identification results as rapidly as possible, the research motivating this system indicteds that operators can become too trusting of the automated agents and simply accept the agents' findings. Further, if the operator is not actively detecting 70 and identifying 76 the aircraft, they do not practice the skills necessary to perform these tasks. Further, it is known that the operators will only be able to detect 70 and identify 76 some number of aircraft and will not be capable of detecting and identifying all aircraft if an adversary were to send a much larger number of aircraft into the airspace. As such, the operator's workload depends on the number of aircraft which must be detected and identified. However, the operator has no control over the number of aircraft that must be detected and identified. Therefore, the operator's workload is driven by the number of events (aircraft entering the airspace) which are present and the operator has no ability to affect this event rate and yet cannot simply ignore aircraft which enter the airspace.

In the preferred embodiment, the ADA 34 may apply the sensor signals to detect 88 an aircraft. As the aircraft is detected, a signal indicating the presence of this aircraft will be provided to update 90 the inter-arrival counter 46. This processor will determine the rate at which new aircraft are entering the airspace. The inter-arrival counter will then provide an inter-arrival signal 48 to one or more agents 34, 36 or to the display rendering engine within the computer. In response to this signal, the agents 34, 36 or the display rendering engine will determine 92 appropriate delays, potentially providing different delays for detection and identification. Based upon this signal, the agents or the display rendering system decide when to update the display 14 with information such as the detection or classification of the aircraft. For example, during times that the inter-arrival time is low the agents or the display rendering system may compare the aircraft detected by the system to the aircraft detected by the operator and decide 94 if it has detected any aircraft that the operator has not detected for longer than the detection delay. If an aircraft has gone undetected by the operator for greater than the detection delay, the agent may annotate, such as by highlight 80, the aircraft on the display to help the operator detect the aircraft. By highlighting the aircraft, the operator is more likely to detect the aircraft and can either begin to identify 76 the aircraft or ignore it. Although not shown, the operator may even disagree with the detection and indicate that no aircraft exists. Once detected, the agents can register 96 with known aircraft and identify 98 the aircraft. Again, it does not necessarily display this identification immediately but determines 100 if the operator has failed to identify this aircraft within the permissible delay time. Only if the aircraft has not been identified within the permissible delay, it will update the display 14 to display 86 the aircraft ID. This identification may be shown as indicated by 38. Additionally, the display rendering engine may render the aircraft with special graphics, such as the oval around the aircraft, indicating that the detection and identification was performed by automated agents 34, 36 rather than the human, providing the human the ability to review 86 the identification and re-identify the aircraft if necessary. However, if the inter-arrival time is large compared to the human's ability to identify the aircraft, the agents 34, 36 or the rendering engine 38 will not immediately update the location and identification of the aircraft but instead may select a delay time before displaying this information to the operator. Therefore, the operator is given time to provide an independent assessment of the presence of the aircraft and to identify the aircraft. It should be noted that the delays used by all agents may not be the same. For example, the delay used by the ADA 34 may be shorter than the delay used by the ACA 36. As such, the user is aided by the automation by having the automation provide an initial detection of the aircraft. The user is then provided a period of time to identify the aircraft before the ACA 36 provides an identification of the aircraft.

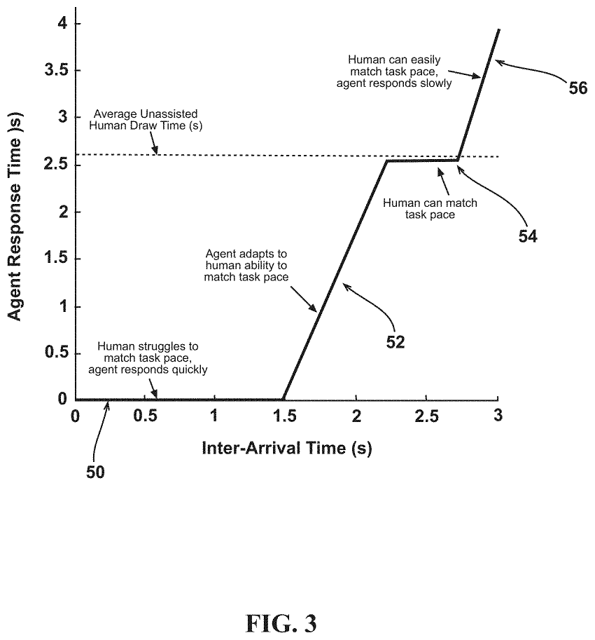

FIG. 3 depicts a graph indicating the response time of the system as a function of the inter-arrival time as a piece-wise linear function. This graph was determined for a system in which the human response time was approximately 2 s. As shown, in this graph, the agents may respond without delay when the inter-arrival time is much lower than the rate at which the human can detect and or identify the aircraft 50. As the inter-arrival time approaches the time required for the human to detect and identify the agent, the agent response time begins to increase 52. The agent response time is then flat 54 for times that are consistent with the time the human needs to detect and identify the agent. Finally, the agent response time may increase further 56, once the inter-arrival time is much slower than the human operators are capable of detecting and identifying aircraft. As a result, the agents become so slow as to be useless to the human and the human will perform the tasks without input from the agents. Although not shown for inter-arrival times that 4 times or higher than the human's response time, the agents may once again utilize a more rapid response time. For example, in FIG. 3 for inter-arrival times greater than 10 s, the agent response time may return to the level indicated by 54 in the figure.

Identifying a Possible Function for Artificial Agent Adaptation in Variable Task Rate Environments:

Research was conducted to identify a method to calculate agent response time (ART) as a function of inter-arrival time (TAT), which balances human-agent team performance, human engagement, and human workload. A human-in-the-loop experiment evaluated human-agent team performance, as measured by team score, human engagement, as measured by the number of manually performed tasks, and workload, as measured through a subjective questionnaire, as a function of IAT and ART combination. Results demonstrated that task IAT strongly correlated with performance, engagement, and workload, while ART strongly related to engagement. Optimization was applied to the resulting data to determine ARTs which maximized performance while sustaining desirable levels of human engagement and workload. The optimization produced an ART function for application in future research to judge the effectiveness of adapting ART to boost human-agent team performance.

Humans and artificial agents can be teamed together to complete intricate and vital tasks. Successful task completion relies on the balance of human engagement and workload within these teams. For example, an unengaged human operator experiencing underload can face decreased alertness (Parasuraman, 2008). Dynamic function allocation is a common adaptive automation method for maintaining proper workload balance (Schneider, Bragg, Henderson, & Miller, 2018). However, this type of function allocation can force the human to maintain awareness of their present tasks within the current allocation, effectively increasing mental workload (Kaber, Riley, Tan, & Endsley, 2001).

Previous research conveyed that agent responsiveness within a human-agent team can affect human engagement (Goodman, Miller, Rusnock, & Bindewald, 2017). This discovery suggests that a well-timed agent response could provide an alternative approach to achieving the proper balance between human engagement and human workload in systems employing adaptive automation. For situations where environmentally-imposed inter-arrival time (IAT) heavily influences operator workload, calculation of optimal agent response time (ART) as a function of IAT becomes a possible method for task load sharing. The current study varied IAT and ART, measuring their effects on human-agent team performance, human engagement, and human workload. The data collected from this study produced a function for desired ART as a function of IAT to support future research.

Method:

Participants:

The experiment involved 14 participants (9 male and 5 female). Two participants were left-handed. Mean participant age was 25.4 years and ranged from 20 to 31. One participant had previous experience with the experimental environment. All but one participant exhibited normal color vision using the Ishihara Color Deficiency Charts (Ishihara, 2012). The participant with apparently irregular color vision obtained the third highest recorded score, indicating their ability to successfully identify the items in the game. Therefore, the analysis included their data. Participants self-reported spending an average of 48.7 hours per week using a computer or similar machine.

Apparatus and Environment:

The experiment used a touch-screen tablet application titled “Space Navigator.” Space Navigator closely resembles commercially-available air-traffic-control games. In this game, a human and agent work together as peers to achieve the highest score possible. The object of Space Navigator is to navigate red, blue, yellow, or green ships that spawn onto the screen to planets of their corresponding color, while obtaining randomly-appearing bonuses during their routes. The human-agent team receives 100 points upon successful navigation of ships to their corresponding planet. Ships are removed from the screen when they arrive at their appropriate planet. Additionally, the human-agent team receives 50 points for navigating ship paths through bonuses that appear on the screen. A bonus appears at a random on-screen location once every 10 seconds and remains on-screen until collected by a ship. The team loses 200 points when two ships collide. The human can physically draw a ship path with their finger, but if the human does not draw a path within a specified time window, the artificial agent presents a straight-line path from the ship to its appropriate planet. However, this agent path does not account for any bonuses or the paths of any other ships on screen. The human can draw or redraw a route at any time. The agent cannot overwrite a human-drawn route. Participants played all games on a Microsoft Surface Pro 4 in a quiet and secluded location.

Experimental Design and Procedure

The input variables to this study were agent response time (ART) and inter-arrival time (TAT). ART is the time an agent waits to draw a route for a new ship. IAT is the number of seconds between the times that two subsequent ships appear. Previous research narrowed and tested a range of IAT and ART values from 2 s to 4 s and 2.6 s to 8.6 s, respectively (Schneider et al., 2018). This research analyzed how the ratio of ART to IAT, referred to as the Adaptation Coefficient (AC), affects score, engagement, and workload (Schneider et al., 2018).

Decreasing IATs result in more ships appearing within a given time. This has the apparent and desired effect of increasing task load by requiring the human-agent team to provide more routes within a given time interval. Since these ships remain in the environment for a period of time to transit to their destination planet, the density of ships in the environment increases, increasing the probability of collisions, and reducing the number of possible collision free routes within the environment. This effect further increases task load as the human must draw or redraw longer and more complex routes.

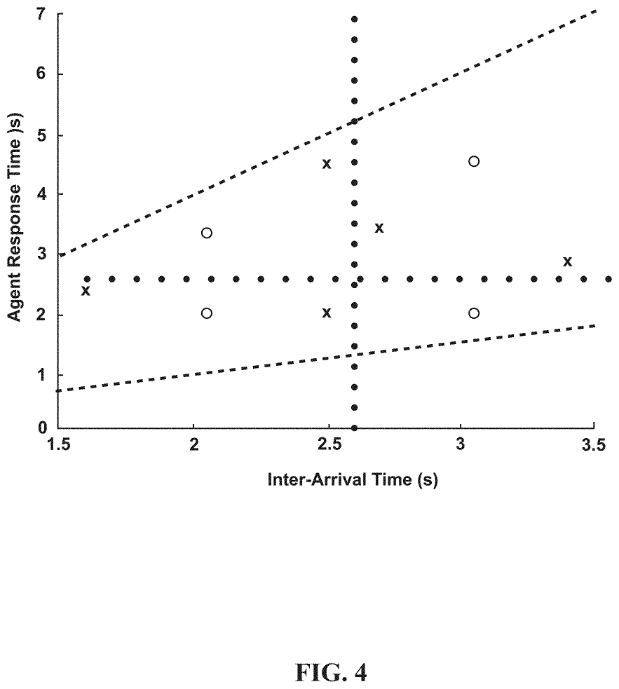

FIG. 4 is a graphical depiction of Inter-Arrival Time (IAT) and Agent Response Time (ART) points sampled during the current experiment (shown as x's and o's). FIG. 4 displays the IAT and ART points used in this experiment, illustrated by points with markers “x” and “o”, respectively. Past studies narrowed the sampling area to boundaries and points featured in FIG. 4 by demonstrating team performance in the experiment environment remained similar for IAT values greater than 3.4 s (Goodman et al., 2017; Schneider et al., 2018). The dashed lines that create the top and bottom boundaries represent AC of 2.0 and 0.5, respectively. These AC were chosen because they represent locations of manageable human workload in the Space Navigator environment, as discovered in previous research (Schneider et al., 2018), although human-agent team performance varied within this range. When TAT is significantly less than 2.6 s, the human will struggle to keep up with new tasks, thereby experiencing overload. When TAT is significantly greater than 2.6 s, the human will experience large breaks between new tasks, thereby experiencing underload. As ART decreases, the human typically draws routes slower than the agent, which could prevent the human from drawing and thereby decrease human engagement. Conversely, as ART increases, the human can draw routes faster than the agent, so one might assume that human engagement increases.

The vertical and horizontal dotted lines indicate the average human draw time of 2.6 s. The sloped dashed lines indicate a range of values useful for human-machine teaming based on previous research. Points marked with an “o” in FIG. 4 represent the centroid of each region within the boundaries provided by the dashed and dotted lines. Points marked with an “x” were selected to be near the boundary extremes to provide insight into human performance near these transition regions.

For each experimental session, the research administrator provided a demonstration of Space Navigator to participants from a narrated script. The participants then played three, 2.5 minute practice rounds, each with an agent teammate, to become familiar with the Space Navigator environment. Practice rounds contained slower than average IAT and ART values to give participants time to understand the mechanics of the game and touchscreen response.

Participants received no gameplay strategies during training.

The experimental session for each participant contained two blocks. Each block included nine, 1.75 minute trials with a workload questionnaire administered after each trial. Game time remained constant in all trials. Each block presented each input point described in FIG. 4 to participants in a random order. A five-minute break separated the two blocks.

Data Analysis:

Each experimental round contained the same game duration but employed different IAT. Thus, a different number of ships appeared in each experimental round. Therefore, it was inappropriate to compare the number of routes drawn and the total score across each experimental round as changes in IAT influenced these variables. To account for this difference, performance was measured as the percentage of the maximum possible score obtained in a game. Furthermore, engagement was calculated through two measures: human draws (HD) per ship and HD per second. When experiencing small IATs, the user may struggle to draw a route for every ship, even if the user desires to draw a manual route per ship. However, this does not mean the user is less engaged in the task than rounds where the user is physically capable of drawing a route for every ship. Therefore, it was desirable to use HD per second to measure overall engagement of a human at each IAT and ART point. However, HD per ship still proved useful for defining thresholds (i.e. we can say the human must at least engage with one in every five ships). Workload was measured using a subjective questionnaire containing three questions from NASA-TLX on a 0-20 scale. These questions were selected as previous studies found a correlation between the workload categories of temporal demand, effort, and performance with changes in IAT (Schneider et al., 2018). Workload values were standardized using min-max normalization within each participant to allow comparison across all participants. Total workload for a single Space Navigator round was calculated as the sum of the normalized workload values for each of the three workload questions.

Relationships between our independent and dependent variables were investigated using multiple regression analysis. This analysis contained two steps. First, multiple regression analysis on output variables was conducted to the third order. Second, insignificant effects were removed one at a time until only significant effects remained. Regression analysis was applied for each output variable across all participants. If large participant variability caused no significance for IAT and ART across all participants, regression analysis was conducted on the mean output values for each input IAT and ART combination.

Results and Discussion:

TABLE 1

| | Avg. % Max | Avg. HD per | Avg. HD per | Avg. Std |
|---|---|---|---|---|
| | Score | Ship | Sec | Workload |
| IAT | 0.9229 | 0.6385 | −0.7969 | −0.9578 |
| (IV) | | | | |
| ART | 0.0018 | 0.8481 | 0.3955 | 0.0006 |
| (IV) | | | | |

TABLE 1 displays correlations of IAT and ART with human-agent team performance, human engagement, and workload. Values in bold represent significant correlation at a=0.05. Italicized data points represent significant correlation at a=0.10. Results indicated IAT strongly correlates with score (r(8)=0.9229, p=0.0004), engagement (r(8)=−0.7969, p=0.0642), and workload (r(8)=−0.9578, p<0.0001). Results also indicated that ART strongly correlates with engagement (r(8)=0.8481, p=0.0039). From Table 1, it becomes evident that as IAT increases, the percent of maximum possible score increases, human draws per ship increases, and workload increases. Additionally, TABLE 1 illustrates that as ART increases, participant engagement with the system increases. These results are consistent with data obtained in preceding research (Schneider et al., 2018).

Multiple regression analysis on the data across all participant trials indicated that there was a collective significant effect between IAT and ART on percentage of max score, F(5, 246)=25.4565, p<0.0001, R2=0.3410. Further examination of the predictors indicated that IAT (t=

6.14, p<0.0001, B=0.1404), IAT to the second degree (t=−3.42, p=0.0007, B=−0.1288), ART (t=−3.15, p=0.0018, B=−0.1263), ART to the second degree (t=−2.96, p=0.0034, B=−0.0812), and ART to the third degree (t=2.84, p=0.0049, B=0.0757) were significant predictors in this model.

Multiple regression on data across all participant trials indicated there was a collective significant effect between IAT and ART on human engagement represented as human draws per ship, F(2, 249)=16.1716, p<0.0001, R2=0.1150. Further examination of the predictors indicated that IAT (t=2.78, p=0.0058, B=0.0890) and ART (t=4.29, p<0.0001, B=0.0746) were significant predictors in this model.

Multiple regression analysis to on data across all ART and IAT combination averages indicated there was a significant effect between IAT and ART on workload, F(4, 4)=130.1843, p=0.0002, R2=0.9924. Further examination of the predictors indicated that IAT (t=−18.71, p<0.0001, B=−0.2345), ART (t=4.94, p=0.0078, B=0.0377), ART to the second degree (t=−

3.39, p=0.0275, B=−0.0265), and the interaction of ART and IAT (t=3.08, p=0.0370, B=0.0535) were significant predictors in this model.

Derivation of Near-Optimal Agent Response Function:

To determine the optimal ART, the regression equations derived in the previous section were applied within an optimization problem. The optimization problem was solved for the ART at each IAT value between zero and four seconds on a 0.001 s interval. This optimization sought to maximize the percentage of maximum score subject to the constraints that the participant would draw at least one route for every five ships and would have a mean standardized workload between the mean, plus or minus one standard deviation of the workload from this experiment (between 0.423 and 0.561).

The optimization determined that when IAT is less than approximately 1.5 s, the optimal ART is 0 s. In this range, IAT is much lower than the average human response time, so the human will likely struggle to match the pace at which new tasks appear. Therefore, the human will likely require shorter ART. Once IAT is greater than 1.5 s, the ART increases as IAT increases, permitting the human to take on a more involved role since they can better keep up with the slower rate at which tasks appear. As IAT approaches the average human response time, it disrupts the linear function. This permits a constant ART for IAT near the average human response time. ART then continues to increase once IAT is greater than the average human response time. Violation of the constraints specified in the function occurred at IAT greater than 3 s. For this reason, ART at IAT greater than 3 s was extrapolated from the function starting at IAT of 2.7 s. As IAT increases from 2.7 s, the human has more time to complete present tasks until the next ship arrives. Therefore, human need for agent assistance remains low at IAT levels greater than 2.7 s. Optimization produces a piecewise linear function for the calculation of the optimal ART based on IAT. Equation 1 provides this piecewise linear function.

For IAT<1.485,ART=0

For 1.485−5 IAT<2.206,ART=3.5327*IAT−5.2461

For 2.206−5 IAT<2.735,ART=2.5471

For IAT 2: 2.735,ART=5.2807*IAT−11.8955 (1)

Conclusion: Results from this study indicate that IAT is strongly correlated with human-agent team performance, human engagement, and workload. Furthermore, ART is correlated with human engagement. This study produced a method for computing ART as a function of IAT. The ART function was obtained by gathering data at logical IAT and ART points and calculating which ART produced the maximum percentage of possible team score while following workload and engagement constraints. The proposed ART function will be applied in subsequent research to determine if ART calculated from IAT can effectively balance workload and engagement while maintaining equal or better performance than a constant ART agent.

References: The following references cited herein are hereby incorporated by reference in their entirety.
(a) Goodman, T. J., Miller, M. E., Rusnock, C. F., & Bindewald, J. M. (2017). Effects of agent timing on the human-agent team. Cognitive Systems Research, 46, 40-51. https://doi.org/10.1016/j.cogsys.2017.02.007.
(b) Ishihara, S. (2012). Ishihara's design charts for colour deficiency of unlettered persons. Retrieved from https://scholar.google.com/scholar?hl=en&as_sdt=0,36&q=ishihara%27s+design+charts+for+colour+deficiency.
(c) Kaber, D. B., Riley, J. M., Tan, K.-W., & Endsley, M. R. (2001). On the Design of Adaptive Automation for Complex Systems. International Journal of Cognitive Ergonomics, 5(1), 37-57. https://doi.org/10.1207/515327566IJCE0501_3
(d) Parasuraman, R. (2008). Supporting Battle Management Command and Control: Designing Innovative Interfaces and Selecting Skilled Operators. Fairfax, Va. Retrieved from http://www.dtic.mil/docs/citations/ADA480645.
(e) Schneider, M. F., Bragg, I. L., Henderson, J. P., & Miller, M. E. (2018). Human Engagement with Event Rate Driven Adaptation of Automated Agents. In 2018 IISE Annual Conference. Orlando, Fla.

Impact of Artificial Agent Timing in Variable Inter-Arrival Time Environments:

The current research explores the use of adaptive agent timing as an alternative to dynamic function allocation to enhance human-agent team performance within an adaptive automation framework. This research utilized an agent with an adaptive Agent Response Time (ART) which was adjusted in response to a variable inter-arrival time (IAT). The ART was designed to maximize human-agent team performance while constraining the solution to maintain desirable levels of human engagement and workload. The resulting agent with the designed ART was compared against an agent having a fixed ART in a human-in-the-loop experiment which employed a variable IAT environment. Instructions were varied between participant groups, with one group receiving an explanation of the expected behavior of the two agents. The adaptive agent successfully reduced the number of tasks performed by the human under high event rate (i.e., small IAT) conditions without sacrificing performance. At low event rates (i.e., large IAT) the number of tasks and therefore engagement, of the human increased as desired. However, the participants found the adaptive ART agent was less predictable and induced higher workload, making the adaptive ART agent appear less desirable than the fixed ART agent. These results help to identify insights into the construction of adaptive ART teammates and considerations for ART agents within human-agent teams.

Introduction

A common belief in the engineering community is that automating tasks invariably enhances system performance [1], [2]. Many highly autonomous systems limit human involvement by placing them in the role of supervisor to the automation [3], [4]. However, this approach often limits the potential of the human-machine team to leverage each member's unique strengths and fails to recognize that machines are incapable of completing the full range of human tasks [4], [5]. It can also lead to human complacency where greater effort is required to maintain acceptable levels of alertness [6].

As tasks require more induction and expertise, they require more human interaction for successful completion [7]. Conversely, as tasks become more repetitive and skill-based, they demand the precision of automation for a high rate of successful completion [7]. Tasks which require various levels of expertise to accomplish (e.g., are composed of knowledge- as well as rule- and skill-based subtasks) are likely to require some form of collaboration between a human and an automation. This viewpoint contrasts with the viewpoint of task allocation in the traditional literature that regarded task allocation between a human and an machine as mutually exclusive [8], [9]. Based on this viewpoint, determining an effective strategy for allocating shared human-machine work becomes a suitable research path.

The predominant perspective on allocating task responsibility for shared human-machine team activities is to avoid methods that inadvertently increase human workload, especially in time constrained environments. Many systems produce variable workload, with higher workload occurring during certain mission phases or under certain environmental conditions. One approach to designing the partnership between humans and automation within these environments involves adaptive automation wherein the proportion of work allocated to the automation increases to alleviate peaks in human workload [10], [11]. Traditionally, adaptive automation has employed dynamic function allocation [12], wherein the automation assumes responsibilities for additional functions to reduce human workload. However, this method for implementing adaptive automation can inadvertently increase mental workload by forcing the human to remain cognizant of their current responsibilities as the automation adapts its responsibilities, providing another source of mental workload [12]. Therefore, other methods for adapting automation may be worth exploring.

Previous research has suggested that the response time of the automation will likely affect the division of work between a human and the automation [4], [13]. Furthermore, recent research has demonstrated that automation response time affects human engagement and workload within an event-driven environment [4]. This suggests that team performance could be enhanced through changes in automation timing as opposed to changes in function allocation [4], [14]. Adapting the automation's timing, as opposed to adapting its functionality might reduce the required mental workload on the human, who must adapt their behavior in response. This approach may also limit so-called mode confusion [15]. Changes in the appropriate automation timing within highly-dynamic, variable task-load environments could involve calculating automation response time based on the rate at which new events or tasks appear [14].

The current research attempted to understand the utility of an adaptive automation system which provided task assistance that varied as a function of event rate. The timing of the automation was adapted to influence task sharing by responding more rapidly in response to higher event rates than lower event rates. Specifically, it was hypothesized that human-automation performance would improve and that better human engagement and workload balance would occur when the timing of the automation varied with changes in event rate than when the timing of the automation was fixed. Additionally, it was hypothesized that participants who are informed of the automation logic for adapting its timing will perform better and achieve better engagement and workload balance than participants who are naive to the automation logic.

Method

An experiment was designed to compare human-machine team performance, human engagement, and workload between an automated teammate with a fixed response time to a teammate with a response time which varied with event rate.

Participants

Thirty-two participants (29 male and 3 female) took part in the experiment. The mean participant age was 28.4 and ranged from 22 to 42 years. All participants completed the Ishihara Color Deficiency Charts prior to the experiment [16]. On average, participants self-reported spending 46.9 hours per week using a computer or similar machine.

Apparatus and Environment

During the experiment, the participants used an application titled “Space Navigator” running on a Microsoft Surface Pro 4. Space Navigator is a task environment which resembles an air-traffic-control task in which the goal is to navigate red, blue, yellow, or green ships that spawn outside the edges of the display screen to planets of their corresponding color. A ship was selected using the touch screen and the desired route was drawn on the screen by sliding one's finger along the desired path. The ships were constantly in motion and enter the screen at a random location on the border with a random direction. The ships proceeded in this direction until the human or the automation provided a route to follow. If the route did not end at a planet or result in a collision, the ship continued along its current trajectory once it reach the end of its assigned route. FIG. 5. is a depiction of a space navigator task environment. A monochrome image of the task environment is shown in FIG. 5. Bonuses could be obtained by drawing the routes of the ships through randomly appearing icons. However, the location of the bonus icons did not necessarily facilitate the shortest route to a given planet.

In this experiment, artificial agents were designed to perform automation, i.e., perform a task traditionally performed by the human [15], by drawing routes between a ship and planet for at least a portion of the ships within the environment. The artificial agents in this environment exhibit autonomy or agency as they have the authority to decide [16], whether a route will be automatically drawn. Additionally, the agent having an adaptive response time has the authority to decide when a route will be drawn. The participant and the artificial agent work together as teammates. However, the human has override authority to achieve the highest game score possible. The human-agent team receives 100 points upon successful navigation of ships to their corresponding planets. Ships are removed from the screen when they arrive at the appropriate planet. The human-agent team loses 100 points per ship when two or more ships collide. Additionally, the human-agent team can receive 50 points for navigating ships over bonus icons that appear on the screen. A bonus appears at a random location once every 10 seconds and does not disappear until collected by a ship. As such, the participants generally made small deviations in routes to gather bonuses.

To create a shared workload environment, the agent's response was delayed to permit the human the opportunity to participate in the ship routing task. Thus, the human had the option of drawing initial routes for the ships or acquiescing this duty to the artificial agent. The artificial agent, however, only drew a straight path from the ship to its appropriate planet; it did not account for any bonuses or the path of any other ships on screen. Therefore, its performance was sub-optimal and the human performed the task of monitoring and redrawing routes to avoid collision. The human could draw or redraw a route at any time. The automated agent could not overwrite any route. Routes drawn by the human were displayed in light blue while routes drawn by the automated agent were displayed in red.

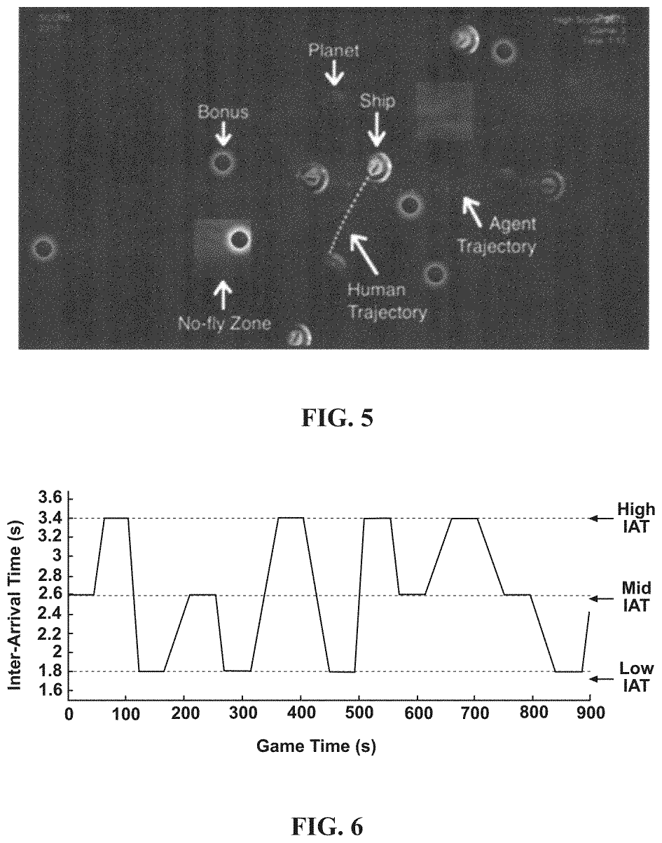

FIG. 6 is a graphical depiction of Inter-arrival time (IAT) as a function of task time. The experiment began with a 15 minute long experimental trial in which the IAT of the ships varied between three levels, as shown in FIG. 6. The high IAT level was defined as 3.4 s. IATs larger than 3.4 s result in situations where virtually all human operators can successfully route all ships in Space Navigator. The low IAT level was defined as 1.8 s. IATs smaller than 1.8 s result in situations where virtually all human operators find it impossible to physically draw routes for all ships in Space Navigator when playing the game without assistance. The moderate IAT level was defined as 2.6 s. Previous research has indicated that this agent response time is the average time a person requires to draw a route in this environment without assistance [4] while playing the game with a 2 s IAT without an assistive agent. The input IAT function remained at each IAT level for 45 s before transitioning to a different IAT level at either the rapid (15 s transition) or relaxed (45 s transition) rate. For example, as shown in FIG. 6, each trial began with a 2.6 s IAT for the first 45 s, a rapid, i.e., 15 s, transition then occurred to a 3.4 s IAT. After 45 s, a rapid, i.e., 15 s, transition occurred to an IAT of 2.6 s for 45 s. Then a relaxed transition, i.e., 45 s transition, occurred to an IAT of 2.6 s. The number of IAT levels and transition rates between levels were divided equally throughout the duration of each experimental trial.

It is worth noting that as IAT decreases, the density of ships in the environment increases, increasing the probability of collision [17]. Therefore, the increasing rate of ship arrivals increases both the number of routes that must be created, as well as the difficulty and time pressure on route creation. Conversely, increases in IAT also reduce the probability of collision and thus the urgency of route creation, which has the potential to reduce human engagement.

The baseline condition in the current experiment employed an agent with an ART fixed at 2.6 s. This ART provides near optimal performance and reasonable human engagement across a range of IATs [18].

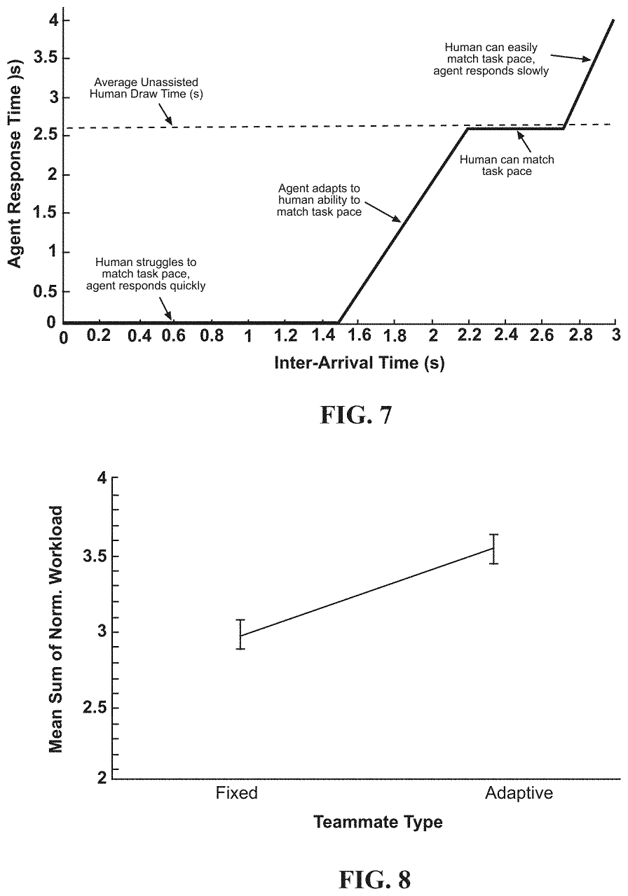

In addition to the fixed ART agent, the current experiment employed a variable ART agent, which utilized the ART function shown in FIG. 7. This function was derived from earlier research [19] which characterized team and human performance across a broad range of IAT and ART conditions and applied these conditions within an optimization which attempted to maximize score, subject to avoiding less than desirable levels of workload and engagement at each IAT.

FIG. 7 is a graphical depiction of ART as a function of IAT, with linear regions are labeled to indicate the desired functionality of the agent within each region. As shown in FIG. 7, the agent was designed to draw a route as soon as a ship was generated when the inter-arrival time was less than 1.5 s. As IATs less than 1.5 s resulted in unmanageable workload for a human working alone, instantaneous generation of the route by the artificial agent provided a maximum team score. In this region, humans were incapable of drawing a significant number of the required routes and this automation permitted the humans to focus on rerouting ships to avoid collisions. As the inter-arrival time increased, to a value greater than 1.5 s, the agent slowed such that at an inter-arrival time of about 2.1 s, the agent drew a route after a 2.6 s delay. This same ART persisted for IATs between 2.1 and 2.7 s. In the IAT range between 1.5 s and 2.7 s total task load decreased as IAT increased. In this range score as maximized within the optimization by reducing the ART, encouraging greater human involvement in initial draws. Finally, for IATs greater than 2.7 s the human was capable of matching the task pace and the automated agent was not required. Therefore, the artificial agent was designed to respond more slowly as the IAT increased. Within this region, the optimization was constrained by the minimum engagement limit. Thus score was not optimized in this region. As the artificial agents have been designed to perform as a teammate to a human operator, these artificial agents will be referred to as teammates throughout the remainder of this document.

Experimental Design and Procedure

The input variables to this experiment were type of ART teammate, instruction and order of teammate presentation. Type of ART teammate is a categorical, counter-balanced, within-subjects variable with values of “fixed” and “adaptive.” If fixed, the ART for the teammate remained at the average human draw time of 2.6 seconds for the experimental trial. If variable, the ART for the teammate was calculated as a function of IAT using the function shown in FIG. 7. Instruction is a counter-balanced, categorical, between-subjects variable that indicates whether the participant received instruction on how their teammate would respond prior to playing the game. The variable of teammate order was counter-balanced and included fixed or adaptive ART teammate first. One fourth of the participants received each combination of instruction and teammate order. A final within-subjects, independent variable of IAT level was introduced when analyzing data within levels of the IAT function. IAT level is a categorical variable that represents a time within the input IAT function where IAT remains constant at 1.8, 2.6, or 3.4 s.

The participants were given a scripted introduction to the game environment to explain the rules and game dynamics. Half of the participants were informed that the response time of the adaptive ART teammate would vary as a function of IAT. Specifically that it would respond faster as more ships arrived and respond slower when fewer ships arrived. This instruction permitted the participants to predict the changes in behavior of the adaptive ART teammate by observing the rate at which new ships were being generated in the environment.

The participants played a single 2.5 minute practice trial with each of the two types of teammates before beginning the first trial. A 5 minute break separated experimental trials to address any participant fatigue. Workload was measured using the NASA TLX questionnaire with a 0-20 scale. The participants received the questionnaire after each experimental trial. Upon completion of the experiment, an open-ended questionnaire asked participants whether they preferred the fixed ART teammate or the adaptive ART teammate.

Data Analysis

Data analysis was performed in two phases. First a three-factor MANOVA was used to compare the effect of teammate type, instruction, and teammate order and on the response variables. As participants received the same number of routing tasks across all experimental trials, the output variables did not require normalization. In the second phase, the portion of each experimental trial corresponding to each IAT was analyzed separately using a four-factor MANOVA to assess the effects of teammate type, instruction, teammate order, and IAT on the response variables. Data collected during the transition between IAT levels was discarded during this phase of the analysis. As the number of ships generated varied with IAT condition, the response variables were normalized to provide comparable values. Team performance was normalized by dividing the total score obtained by the human-agent team in a single trial by the maximum possible score. Engagement was measured as the total number of human draws and redraws for a single trial in the first phase. These values were normalized by the number of ships when analyzing the effect of IAT. Workload values were normalized using min-max normalization within each participant to allow comparison across all participants. Workload was measured as the sum of the normalized workload values for each of the six workload questions. Since workload values were obtained at the end of each trial, no workload data was available at specific IAT intervals.

ANOVA was subsequently applied to analyze the results for each dependent variable. When appropriate, the Greenhouse-Geisser correction was applied to correct the degrees of freedom for any violations of the sphericity assumption for within-subjects effects as indicated through the application of Mauchly's sphericity test. Finally Tukey tests were applied to understand the differences between mean IAT levels.

Results

Performance Across Trial

The three-factor, mixed-design MANOVA indicated that the effect of teammate type F(4,25)=5.17, p=0.004, ηₚ²=0.45 and the interaction of teammate type and order F(4,25)=9.99, p<0.001, ηₚ²=0.617 were significant. Further, the effect of instruction neared statistical significance F(4,25)=2.36 p=0.081, ηₚ²=0.27. While the effect of teammate order F(4,25)=0.82, p=0.527, ηₚ²=0.12 and the interaction of teammate type and instruction F(4,25)=1.74, p=0.173, ηₚ²=0.22 were not significant.

FIG. 8 is a graphical depiction of mean sum of normalized human workload as a function of teammate type. Error bars indicate plus and minus one standard error of the mean. Subsequent ANOVAs indicated that teammate type predominantly influenced workload F(1,28)=11.6, MSE=0.449, p=0.002, ηₚ²=0.29. The effect of teammate type on workload is depicted in FIG. 8. As shown, workload was higher for the adaptive than the fixed ART teammate. Although teammate type did not have a significant effect on any other dependent measure, the number of human draws approached statistical significance F(1,28)=3.87, MSE=1362, p=0.059, ηp²=0.121, with a larger number of human draws observed for the adaptive ART teammate (i.e., 196) than for the fixed ART teammate (i.e., 171).

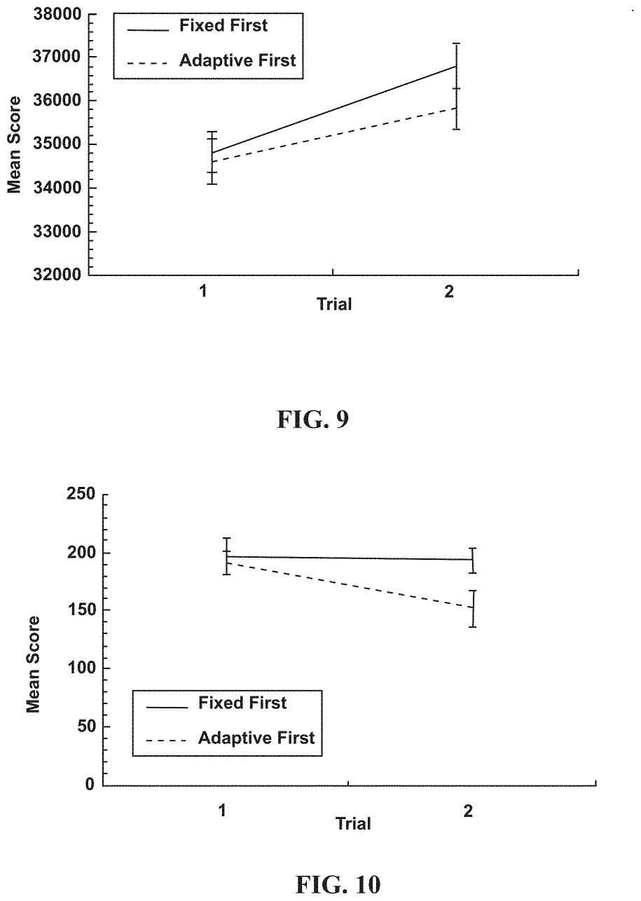

The interaction of teammate type and teammate order was significant for score F(1,28)=24.9, MSE=1683359, p<0.001, ηₚ²=0.47 and number of human draws F(1,28)=5.22, MSE=1364, p=0.030, ηₚ²=0.16. Subsequent two factor MANOVAs indicated that the effect of teammate type was significant both when the fixed ART teammate was encountered first F(3,13)=10.70, p=0.001, ηₚ²=0.71 and when the adaptive ART teammate was encountered first F(3,12)=6.19, p=0.008, ηₚ²=0.59. Subsequent two-factor ANOVAs indicated that only score was significant when the fixed ART teammate was experienced first F(1,15)=12.88, MSE=767869, p=0.003, ηp²=0.46 but both score F(1,15)=16.036, MSE=767869, p=0.003, ηp²==0.30 and number of human draws F(1,15)=6.55, MSE=1880, p=0.022, ηₚ²==0.30 were significant when the adaptive ART teammate was experienced first. FIG. 9 is a graphical depiction of mean score as a function of the interaction of trial and the teammate order. Error bars indicate plus and minus one standard error of the mean.

FIG. 10 is a graphical depiction of mean number of human draws as a function of experimental trial and teammate type order. Error bars indicate plus and minus one standard error of the mean. These effects are shown for score in FIG. 9 and for number of human draws in FIG. 10. As shown in FIG. 9 score is greater for the second trial regardless of teammate order but this increase was larger when the fixed ART teammate was encountered first than when the adaptive ART teammate was encountered first. FIG. 10, illustrates that the mean number of human draws is approximately equal across the two trials when the fixed ART teammate was experienced first. However, the mean number of human draws decreased in the second trial when the adaptive ART teammate was experienced in the first trial.

Analysis of the post experiment questionnaire indicated that of the 32 total participants, 25 participants preferred the fixed ART teammate over the adaptive ART teammate. Thirteen of the sixteen (16) participants who received no instruction and twelve (12) of the sixteen (16) participants who received instruction preferred the fixed ART teammate to the adaptive ART teammate. Thirteen (13) of the twenty-five (25) participants who preferred the fixed ART teammate explicitly used a form of the word “predictable” or “consistent” to describe the teammate.

Performance at Each TAT Level

A four-factor, mixed-design MANOVA was conducted to determine the effect of TAT level in concert with the factors of instruction, teammate presentation order and type of ART teammate on percent of maximum possible score and mean human draws per ship. The effects of instruction F(3,26)=3.42, p=0.032, ηₚ²=0.283, TAT F(4,25)=63.24, p<0.001, ηₚ²=0.910, the interaction of teammate type by IAT F(4,25)=35.19, p<0.001, ηₚ²=0.849, and the interaction of teammate type by teammate order F(3,26)=5.49, p=0.005, ηₚ²=0.388 were all significant. Additionally, the effect of teammate type approached significance F(3,26)=2.80, p=0.062, ηₚ²=0.242. The main effect of teammate order was not significant F(3,26)=1.00, p=0.407, ηₚ²=0.104. The interaction of IAT and instruction, which was expected was not significant F(4,25)=0.865, p=0.499, ηₚ²=0.12.

Further analyzing the main effect of instruction, an ANOVA indicated that participants who received instruction of teammate functionality scored lower than participants who did not receive instruction of teammate functionality, F(1,28)=4.55, MSE=0.01, p=0.042, ηₚ²=0.14. Instruction did not have a significant effect on human draws per ship F(1,28)=0.267, MSE=01, p=0.116, ηₚ²=0.086. FIG. 11 illustrates the mean percent of maximum score as a function of instruction. Error bars indicate plus and minus one standard error of the mean. The percent of maximum score was less when participants were instructed on teammate behavior than when they did not receive instruction.

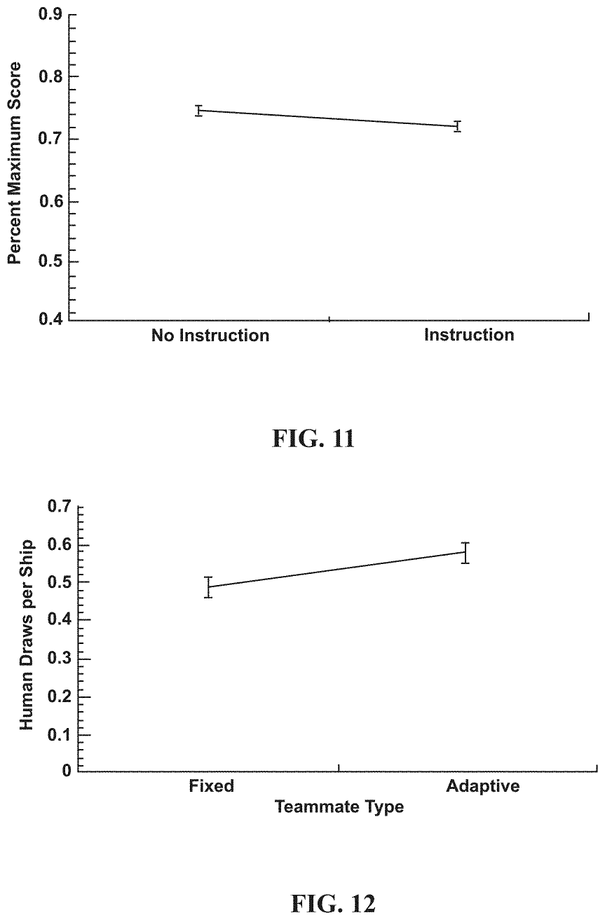

Although the MANOVA indicated that teammate type only neared significance, the ANOVA indicated that teammate type had a significant influence on human draws per ship F(1,28)=8.61, MSE=1.08, p=0.007, ηₚ²=0.24. FIG. 12 is a graphical depiction of effect of agent type on the number of human draws per ship. Error bars indicate plus and minus one standard error of the mean. The effect of teammate type is shown in FIG. 12. As shown, the number of human draws per ship increases from approximately 0.49 for the fixed ART teammate to 0.57 for the adaptive ART teammate.

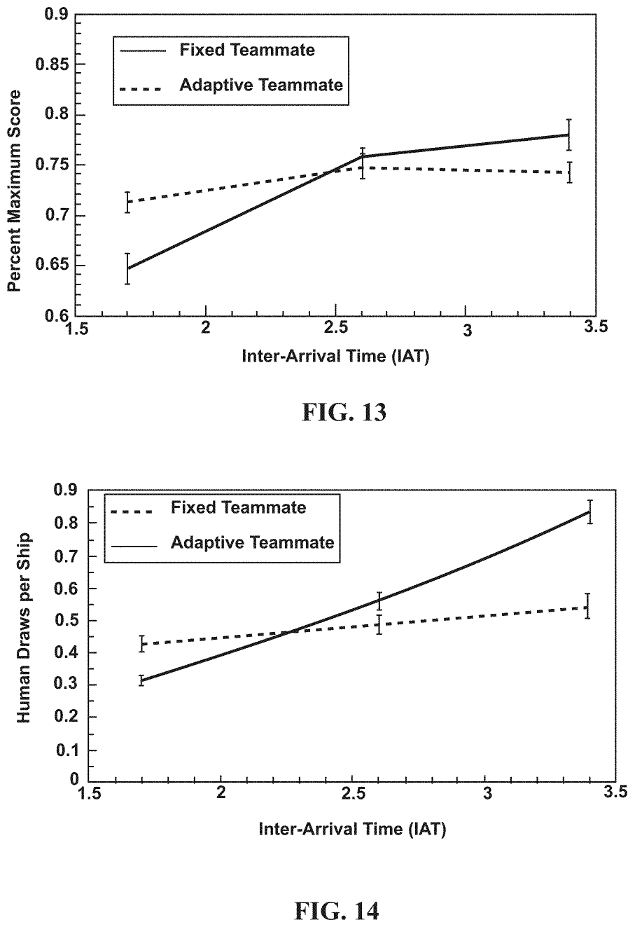

Further, investigating the effect of IAT, subsequent ANOVAs indicated that IAT level had a significant effect on percentage of maximum score F(2,56)=23.16, MSE=0.005, p<0.001, ηₚ²=0.45 and number of human draws per ship F(2,56)=126.02, MSE=, p>0.001, ηₚ²=0.82. Furthermore, the ANOVAs indicated that interaction of IAT level and teammate type had a significant effect on percent maximum score F(1.8, 50.1)=15.19, MSE=0.003, p<0.001, ηₚ²=0.35 and number of human draws per ship F(1.3,50.3)=62.91, MSE=0.012, p<0.001, ηₚ²=0.692. These interactions are shown in FIGS. 13-14. FIG. 13 is a graphical depiction of percent of maximum possible score as a function of ship inter-arrival time (IAT) and teammate type. Error bars indicate plus and minus one standard error of the mean. FIG. 14 is a graphical depiction of human draws per ship as a function of inter-arrival time (IAT) and teammate type. Error bars indicate plus and minus one standard error of the mean.

To further investigate this interaction, one-factor, repeated measures ANOVAs were conducted to compare the effect of teammate type on score for each IAT level. For moderate IAT levels, the ANOVA indicated there was not a significant effect of teammate type on score, F(1,31)=0.52, MSE=0.002, p=0.477, ηₚ²=0.016. For high IAT levels, the ANOVA indicated that participants scored higher with a fixed ART teammate than with the adaptive ART teammate, F(1, 31)=4.15, MSE=0.024, p=0.050, ηₚ²=0.118. For low IAT levels, the ANOVA indicated that participants scored higher with the adaptive ART teammate than with a fixed ART teammate, F(1,31)=18.15, MSE=0.070, p<0.001, ηₚ²=0.369. Overall, FIG. 13 shows that the percent maximum score does not vary as a function of IAT for the adaptive ART teammate, while the percent maximum score generally increases as the IAT increases, indicating that team performance depends on the rate at which ships arrive in the environment.

To further investigate the effect of the interaction of IAT and teammate type on human draws per ship, a series of one-factor, repeated measures ANOVAs were conducted at each IAT level. These analyses indicated that that participants drew more routes for the adaptive ART teammate than with the fixed ART teammate at moderate F(1,31)=4.561, MSE=0.077, p=0.041, ηₚ²=0.128 and high IAT levels F(1,31)=35.680, MSE=1.382, p<0.001, ηₚ²=0.535. However, the one-factor ANOVA also indicated that participants drew fewer routes when working with the adaptive ART teammate than with the fixed ART teammate at low IAT levels, F(1,31)=19.73, MSE=0.205, p<0.001, ηₚ²=0.389. For this variable, humans drew a larger proportion of the routes as IAT increases for the adaptive ART teammate but drew a nearly constant proportion of the routes as IAT increases for the fixed ART teammate.

The relationship for the interaction of teammate type and order were similar when IAT was included as it was in the earlier analysis.

Discussion

Overall, this research explored the utility of an adaptive ART teammate through measurement of human-agent team performance as indicated by score, engagement, as indicated by routes drawn by the human, and workload within an environment with varying event rate. The research hypothesized that these measures would be positively influenced by an adaptive ART teammate, as compared to a nearly optimal fixed ART teammate. This paper now discusses these findings in light of previous research.

Development of an Adaptive Agent

This research explored an adaptive ART teammate with a response time that is calculated based on event rate. The timing of the agent was designed to maximize human-agent team score while maintaining a minimum desirable level of human engagement and workload. The adaptive ART teammate was designed to optimize score over a large range of conditions but prioritized human engagement over performance under very low event rate conditions. The response time of the adaptive ART teammate decreased as the event rate increased beyond the time that an unassisted human required to draw a route. Thus the participation of the adaptive ART teammate increased for event rates faster than human response time. It was posited that this adaptation would boost team performance by reducing human workload to manageable levels. Conversely, the response time of the ART teammate increased when the event rate was lower than the average unassisted human task completion time, the response time of the teammate is adjusted to decrease the participation of the adaptive artificial agent, encouraging the human to adapt to work with less input from the adaptive ART teammate as they were capable of drawing routes much faster than the adaptive ART teammate. Similar functions may be useful in other tasks where the response time of the adaptive ART teammate is dependent upon the time a human requires to perform the shared task. This design assumes that the artificial agent can respond much more rapidly than the human but that the time the artificial agent provides a response or the time that the artificial agent's response is displayed to the human operator is purposefully delayed. This delay then provides the operator time to perform the task independently, permitting the operator to remain engaged in the task and to exercise and improve their skill, preventing skill atrophy [20],

Performance of the Adaptive Agent

It was hypothesized that providing automation that adapted its response time would reduce workload, in contrast to providing automation that adapts its functionality, which is known to increase workload [12]. In support of this hypothesis, it was expected that the workload for the adaptive ART teammate would be lower than the workload for the fixed ART teammate. Contrary to the hypothesis, participants indicated that they experienced higher workload with the adaptive ART teammate than with the fixed ART teammate across the entire IAT function as illustrated in FIG. 8. This increase in perceived workload might be attributed to an increase of cognitive resources necessary to determine the timing of the artificial agent as participants noted the lack of perceived predictability of the adaptive ART teammate during post experiment questionnaires. The need to determine and respond changes in automation behavior is known to increase operator workload [15]. The fact that participants drew fewer routes for the fixed ART teammate than the adaptive ART teammate, as illustrated in FIG. 14 and the participants drew fewer routes when interacting with the fixed ART teammate during times of underload, as shown in FIG. 12, indicates that it is possible that this reduced interaction resulted in the perception of lower workload. As the human was not asked to provide workload estimates while performing at various IAT levels, it is not clear whether the ART teammate increased workload generally or only increased workload during certain IAT levels. The current research assumed that it is desirable for the adaptive ART teammate to react very slowly, causing the operator to act and increasing workload during very low task load. It is possible that this behavior produced a desirable increase in perceived workload. However, the root cause of the increase in perceived workload when working with the adaptive ART agent cannot be determined based upon the results of this experiment and remains a question for future research.

No significant difference existed between score or engagement for type of teammate across the entire IAT function. However, analysis of team performance at specific IAT levels uncovered interesting tendencies not demonstrated when analyzing the data from the trial in entirety. During periods of low IAT, when new tasks appeared rapidly, thus producing high task load, teams scored significantly higher with the adaptive ART teammate than with the fixed ART teammate as illustrated in FIG. 13. This result indicates the adjustment of the adaptive ART teammate to respond in a shorter period of time boosted human-agent team performance during high event rates (e.g., low IAT levels). Conversely, during periods of high IAT, when new tasks slowly appeared, producing low task load, teams scored significantly lower with the adaptive ART teammate than with the fixed ART teammate. Interestingly, this behavior is consistent with the expected behavior. The optimization used to produce the adaptive ART function was not constrained by engagement or workload for IATs less than the average human response time, permitting the optimization to maximize the percent of maximum score. However, the optimization was constrained by engagement or workload for IATs greater than the average response time, providing less than the optimal score to maintain increased human engagement. Although this fact provides one possible source of this effect, it remains a possibility that participants struggled to understand the precise timing of the adaptive teammate, even when provided instruction of agent functionality. This lack of understanding may have led the participants to over-rely on the adaptive ART agent during times of high IAT, degrading team performance within this condition.

While teams scored slightly lower with the adaptive agent than with the fixed agent at high IAT levels, as shown in FIG. 14, they drew a larger percentage of the routes and thus were significantly more engaged with the adaptive agent at these IAT levels as expected. Designing the agent to keep the human more engaged with the system improves the likelihood that they will maintain a higher level of situation awareness [21] and be more likely to respond to automation failures as they are more likely to maintain acceptable levels of alertness without excessive effort [22]. As such, the human should be in a better position to respond to unforeseen automation failures while actively participating with the adaptive agent during task completion as opposed to being left out-of-the-loop [23].

Although the current experiment utilized IAT to trigger changes in the response time of the artificial agent, similar changes could be triggered by other variables. In fact, many of the workload, mission phase, or task load measures known in the literature [24] could alternately be adapted to trigger changes in agent response time to facilitate workload sharing.

It is worth noting that we found many of the findings of Rouse's 1977 paper [13] to be prescient. In this research Rouse applied queueing theory to explore a future system in which events or decisions entered a queue and the human or automated agent responded to the item if available. Based upon the resulting queueing model in which the time and accuracy of the agent, referred to as computer, was varied, Rouse indicated that such a system must permit the human and agent to be aware of each other's actions. Although not discussed, during environment design it became clear that for this system to function, the human and agent must not only be aware of each other's actions but be able to identify the other's actions once they are made such that the human can correct any errors. This was facilitated in our environment by providing different colored paths in the environment depending on whether the human or the automated agent drew the path. Rouse also correctly indicated the importance of changes in ART as a function of event rate. Although this paper indicated the potential utility of varying ART to affect human performance in human-agent teams, it does not appear that implementations based upon this knowledge were explored at the time, perhaps due to the limited computational power available in 1977.

Despite several accurate predictions, Rouse indicated that having an agent which responded faster than the human was capable would provide little value, especially if creating a faster agent reduced its ability. Our research does not support this finding. In the current environment, the human could intuitively detect error conditions (i.e., potential collisions) without a physical response. Therefore, under very short inter-arrival times, as long as the agent immediately provided all initial routes, the human was only required to make a physical response to correct agent-created routes which would result in a potential collision. Therefore, an agent with poor decision-making capability proved to be useful as it permitted the human to adapt from the task of route creation to collision avoidance when the IAT was small. This action on the part of the automated agent reduced the human's need to physically control most entities and provided enhanced team performance.

Instruction and Predictability

It was expected that participants who received instruction on agent functionality would perform better with the adaptive ART teammate than those who did not. However, the results did not support this hypothesis. Instead, as shown in FIG. 11, participants obtained a higher score when no instruction was provided than when instruction regarding the function of the adaptive ART teammate was provided. As indicated in FIG. 9, the results also show that participants obtained a higher score during the second trial than the first and that this increase was larger when the fixed ART teammate was experienced before the adaptive ART teammate than vice versa. Therefore, it would appear that the participants were learning the environment and the behavior of the teammates during the experiment. Consequently, it is possible that the participants who received instruction spent more cognitive resources to understand the behavior of the agents within the environment than participants who did not receive instruction.

Participants overwhelmingly indicated a preference for the fixed ART teammate. The fixed ART agent was described as more “predictable” and “consistent” by the participants than the adaptive agent. Some participants preferred the fixed agent even when scoring higher and exhibiting increased engagement with the adaptive agent. The clear desire for an agent with constant, thus predictable, timing over the adaptive ART teammate suggests the presence of a predictability need. However, the current experiment utilized a rapidly changing task load, demonstrating 12 significant changes in task load within the fifteen (15) minute experimental condition. Perhaps this need for additional predictability will decrease in environments in which task load and teammate timing change gradually or less frequently than in the current experimental environment.

Previous research has demonstrated that predictability of teammate behavior to the human can improve human-machine team performance [25]. Therefore, predictability of an artificial teammate's timing is a trait desired by humans. The experiment environment in this research employed instruction of noticeable phenomena as an independent variable, which together with directly observable graphical interface elements, has been shown to increase human understanding of agent predictability [26]. However, the fact that the current environment provided visibility of new ships and required the human to assess their rate of appearance to predict changes in agent timing, did not appear to provide adequate operator insight into the behavior of the adaptive ART teammate even when the participants were provided instructions describing the behavior of the adaptive ART agent in response to this variable. Perhaps, providing graphical cues or other cues which directly communicate the rate of the adaptive agent would lead to larger increases in human-agent team performance when interacting with an adaptive ART teammate than observed in the current experiment.

Real-World Implications

Given the simple and stable game environment utilized in this research, a well-designed routing agent could replace the human entirely, likely with lower error rate. However, because today's software agents are designed to fulfill functions or activities which might appear in the lower levels of Rasmussen's abstraction hierarchy [28], they are often incapable of forming new goals and creating the processes and activities necessary to fulfill higher level goals. Therefore, these agents are not adept at detecting and responding to changes in the environment which may be imposed by an intelligent adversary. As a result, the need for human involvement in system control will persist in many environments.

This research demonstrated the ability to take advantage of improvements in computational power to influence human engagement, insuring the human remains in-the-loop, by purposefully adapting (i.e., increasing and decreasing) teammate response time within an event-driven environment. The use of a game environment simplified participant recruitment and training, while permitting easy manipulation of the variables of interest and the design of clear team objectives (i.e., maximizing team score). While we might argue the similarity or dissimilarity of the game to other real world tasks, such as air traffic control or base defense, the error rate (i.e., number of collisions) experienced during game play would not be sustainable in most real-world environments and certainly not appropriate in safety critical environments.

The design of the ART function optimized game score subject to workload and engagement constraints. However, because throughput had a greater impact on the objective function (i.e., score) than collision avoidance, the ART function was not optimized to prioritize collision avoidance. Therefore, the timing function used in this experiment is likely not adequate to support most real-world tasks and the objective function originally used to design the ART function would need to be modified to represent the real world consequence of errors to enable the design of an useful ART function.

Conclusion

This research investigated the effect of an artificial teammate which adapted its timing, responding faster when events requiring team response occurred more rapidly than when these events were less frequent. The results indicate that this adaptation provided higher team score during high task load conditions and increased user task engagement during low task load conditions, as desired. Unfortunately, the adaptation increased user workload, decreased the predictability of the adapting teammate, decreased team performance under low task load conditions, and reduced user acceptability. Based on this research, predictability of an agent is a trait of automation sought by humans and predictability appears to include not only the actions [18] but the timing of artificial teammates. Therefore, this adaptation, as implemented, has many of the same concerns as adaptive function allocation. Future research should explore methods to make the adaptation more predictable to human participants and determine whether these methods improve human workload, team performance under low workload conditions, and user acceptance. Additionally, this concept should be explored in environments where the variation in task load, the task, and the functional utility of the artificial teammate are more realistic.

### REFERENCES

The following references mentioned in this section are hereby incorporated by reference in its entirety:
[1] Department of Defense: Defense Science Board, “Task Force Report: The role of autonomy in DoD Systems,” Washington, D.C., 2012.
[2] L. J. Bannon, “From Human Factors to Human Actors: The Role of Psychology and Human-Computer Interaction Studies in System Design,” Readings Human—Computer Interact., pp. 205-214, January 1995.
[3] D. J. Bruemmer, J. L. Marble, and D. D. Dudenhoeffer, “Mutual initiative in human-machine teams,” in Proceedings of the IEEE 7th Conference on Human Factors and Power Plants, 2002, pp. 22-30.
[4] T. J. Goodman, M. E. Miller, C. F. Rusnock, and J. M. Bindewald, “Effects of agent timing on the human-agent team,” Cogn. Syst. Res., vol. 46, pp. 40-51, 2017.
[5] E. Brynjolfsson and T. Mitchell, “What can machine learning do? Workforce implications,” Science, vol. 358, no. 6370, pp. 1530-1534, 2017.
[6] R. Parasuraman, “Supporting Battle Management Command and Control: Designing Innovative Interfaces and Selecting Skilled Operators,” Fairfax, Va., 2008.
[7] M. M. Cummings, “Man versus machine or man+machine?,” IEEE Intell. Syst., vol. 29, no. 5, pp. 62-69, 2014.
[8] P. Fitts, “Human engineering for an effective air navigation and traffic control system,” Ohio State Univ., 1951.
[9] H. E. Price, “The Allocation of Functions in Systems,” Hum. Factors, vol. 27, no. 1, pp. 33-45, 1985.
[10] M. W. Scerbo, “Theoretical Perspectives on Adaptive Automation,” in Automation and Human Performance: Theory and Applications, vol. 514, no. December, M. Parasuraman, Raja; Mouloua, Ed. Mahwah, N.J.: Lawrence Erlbaum Associates, Publishers, 1996, pp. 37-64.
[11] C. E. Billings, Aviation Automation: The Search for a Human-Centered Approach. Mahwah, N.J.: Lawrence Erlbaum Associates Publishers, 1997.
[12] D. B. Kaber, J. M. Riley, K.-W. Tan, and M. R. Endsley, “On the Design of Adaptive Automation for Complex Systems,” Int. J. Cogn. Ergon., vol. 5, no. 1, pp. 37-57, 2001.
[13] W. B. Rouse, “Human-Computer Interaction in Multitask Situations,” IEEE Trans. Syst. Man Cybern., vol. 7, no. 5, pp. 384-392, 1977.
[14] M. F. Schneider, I. L. Bragg, J. P. Henderson, and M. E. Miller, “Human Engagement with Event Rate Driven Adaptation of Automated Agents,” in 2018 IISE Annual Conference, 2018.
[15] N. B. Sarter and D. D. Woods, “How in the world did we ever get into that mode? Mode error and awareness in supervisory control,” Hum. Factors, vol. 37, no. 1, pp. 5-19, 1995.
[16] S. Ishihara, “Ishihara's design charts for colour deficiency of unlettered persons,” 2012.
[17] K. Smith, S. F. Scallen, W. Knecht, and P. A. Hancock, “An Index of Dynamic Density,” Hum. Factors, vol. 40, no. 1, pp. 69-78, 2007.
[18] J. M. Bindewald, M. E. Miller, and G. L. Peterson, “Creating Effective Automation to Maintain Explicit User Engagement,” Int. J. Human—Computer Interact., vol. 0, no. 00, pp. 1-14, 2019.
[19] D. J. Canzonetta and M. E. Miller, “Identifying 4 a possible function for artificial agent adaptation in variable task rate environments,” in 20th International Symposium on Aviation Psychology, 2019, pp. 375-380.
[20] M. R. Endsley and E. O. Kiris, “The Out-of-the-Loop Performance Problem and Level of Control in Automation,” Hum. Factors, vol. 37, no. 2, pp. 381-394, June 1995.
[21] M. R. Endsley and D. B. Kaber, “Level of automation effects on performance, situation awareness and workload in a dynamic control task,” Ergonomics, vol. 42, no. 3, pp. 462-492, March 1999.
[22] J. S. Warm, R. Parasuraman, and G. Matthews, “Vigilance Requires Hard Mental Work and Is Stressful,” Hum. Factors, vol. 50, no. 3, pp. 433-441, 2008.
[23] J. M. Bradshaw, R. R. Hoffman, D. D. Woods, and M. Johnson, “The seven deadly myths of ‘autonomous systems,’” IEEE Intell. Syst., vol. 28, no. 3, pp. 54-61, 2013.
[24] K. M. Feigh, M. C. Dorneich, and C. C. Hayes, “Toward a Characterization of Adaptive Systems: A Framework for Researchers and System Designers,” Hum. Factors, vol. 54, no. 6, pp. 1008-1024, 2012.
[25] G. Klein, D. D. Woods, J. M. Bradshaw, R. R. Hoffman, and P. J. Feltovich, “Ten challenges for making automation a ‘team player’ in joint human-agent activity,” IEEE Intell. Syst., vol. 19, no. 6, pp. 91-95, 2004.
[26] M. Johnson, J. M. Bradshaw, P. J. Feltovich, C. M. Jonker, M. B. Van Riemsdijk, and M. Sierhuis, “Coactive Design: Designing Support for Interdependence in Joint Activity,” J. Human-Robot Interact., vol. 3, no. 1, p. 43, 2014.

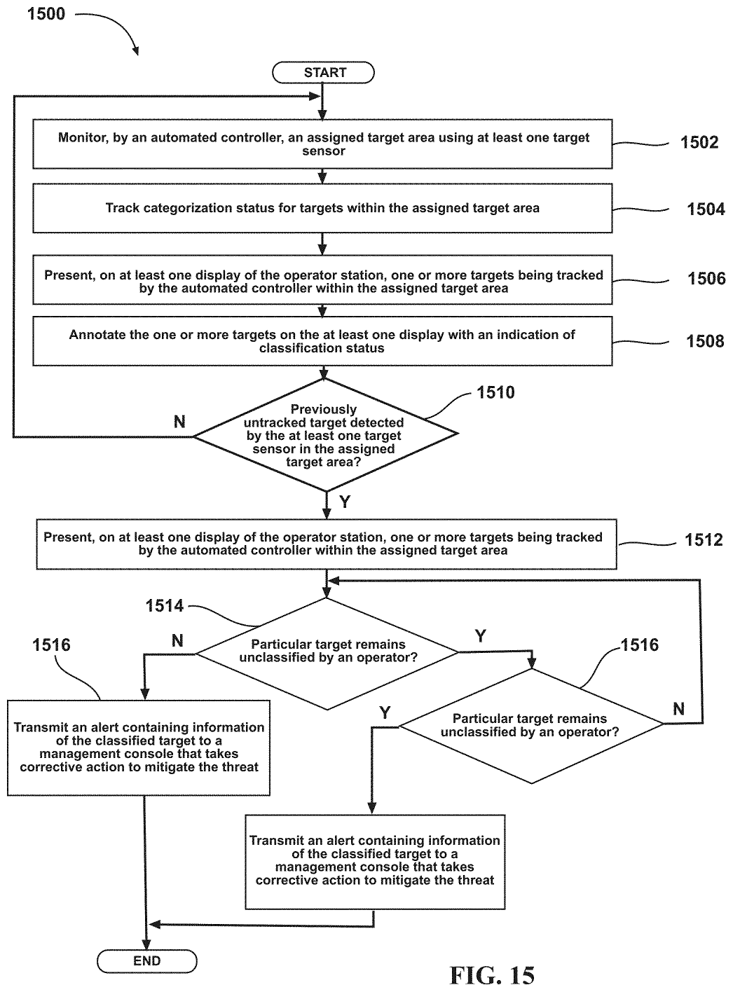

FIG. 15 presents a flow diagram of a method 1500 of human-automation collaborative response. Method 1500 can be executed, for example, by equipment described herein, such as with regard to FIG. 1. In one or more embodiments, the method 1500 includes monitoring, by an automated controller, an assigned target area using at least one target sensor (block 1502). Method 1500 includes tracking categorization status for targets within the assigned target area (block 1504). Method 1500 includes presenting, on at least one display of the operator station, one or more targets being tracked by the automated controller within the assigned target area (block 1506). Method 1500 includes annotating the one or more targets on the at least one display with an indication of classification status (block 1508). A determination is made, in decision block 1510, whether a previously untracked target is detected by the at least one target sensor in the assigned target area. In response to not detecting a previously untracked target, method 1500 returns to block 1502. In response to detecting a previously untracked target, method 1500 includes tracking an amount of time that each target has been presented without an operator response to each target via a user interface device (block 1512). A determination is made, in decision block 1514, whether the particular target remains unclassified by an operator. In response to determining that the particular target has been classified, method 1500 includes transmitting an alert containing information of the classified target to a management console that takes corrective action to mitigate the threat (block 1516). Then method 1500 ends. In response to determining that the particular target remains unclassified, a determination is made, in decision block 1518, whether the particular target has remained unclassified for longer than a first time threshold. In response to determining that the particular target has not remained unclassified for longer than the first time threshold, method 1500 returns to decision block 1514. In response to determining that the particular target has remained unclassified for longer than the first time threshold, method 1500 includes automatically responding to the particular target using an automated agent (block 1520). Then method 1500 ends.

In one or more embodiments, method 1500 includes annotating the one or more targets comprises designating each target with a classification status from among: (i) unclassified; (ii) operator classified; and (iii) automated agent classified. In response to receiving a user input confirming a classification of a particular target by the automated agent, method 1500 includes changing the classification and the annotation of the particular target from automated agent classified to operator classified. In response to receiving a user input overruling a classification of the particular target by the automated agent, method 1500 includes changing the classification and the annotation of the particular target from automated agent classified to unclassified. In one or more particular embodiments, changing the classification of the particular target by the automated agent is further in response to determining that the particular target has been annotated as classified by the automated agent for more than a specified delay interval.

In one or more embodiments, in response to the amount of time that the particular target has been presented without an operator response exceeding a second time threshold that is less than the first time threshold, method 1500 includes automatically annotating the particular target on the at least one display to prompt the operator.

In one or more embodiments, method 1500 includes tracking an inter-arrival time (IRT) of the presentation of the one or more targets. In response to the IRT exceeding a first rate threshold, method 1500 includes reducing the first time threshold. In one or more particular embodiments, in response to the IRT being less than a second rate threshold that is less than the first rate threshold, method 1500 includes increasing the first time threshold.

In one or more embodiments, the assigned target area is a network of information handling systems. The at least one target sensor is a remote agent communicatively coupled to the network information handling system to receive and report workload indications from at least one of the information handling systems. The target is a workload indication that is above a threshold for a particular information handling system. The classification is designating the workload indication as one of: (i) a cyber attack; and (ii) not a cyber attack.

In one or more embodiments, method 1500 includes monitoring the assigned target area using the at least one target sensor by receiving radar returns of an airspace sector assigned to an operator station. Method 1500 includes tracking categorization status for targets within the assigned target area comprises at least one of aircraft detection and aircraft identification. Method 1500 includes presenting, on at least one display of the operator station, one or more targets being tracked by the automated controller within the assigned target area comprises presenting, on at least one display of the operator station, one or more targets based on the radar returns positioned to represent a current location within the air space sector. In one or more particular embodiments, the operator and automated agent responses indicate detection of a particular target being an aircraft and the automated agent is an aircraft detection agent. In one or more particular embodiments, the operator and automated agent responses identify a particular target as being one of a friendly aircraft and an unfriendly aircraft and the automated agent is an aircraft identification agent. In one or more embodiments, method 1500 includes receiving a secondary source of data associated with the one or more targets comprising one or more of infrared data, flight plan data, and kinematic data. Method 1500 includes presenting the secondary source of data on the at least one display of the operator station to assist the operator. Method 1500 includes providing the secondary source of data to the automated response agent that bases an automated response at least in part on the secondary source of data.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method of human-automation collaborative response, the method comprising:
monitoring, by an automated controller, an assigned target area using at least one target sensor;
tracking categorization status for targets within the assigned target area;
presenting, on at least one display of the operator station, one or more targets being tracked by the automated controller within the assigned target area;
annotating the one or more targets on the at least one display with an indication of classification status; and
in response to previously receiving a previously untracked target from the at least one sensor:
tracking an amount of time that each target has been presented without an operator response to each target via a user interface device; and
in response to the amount of time that a particular target has been presented without an operator response exceeding a first time threshold, automatically responding to the particular target using an automated agent.

2. The method of claim 1, wherein:
annotating the one or more targets comprises designating each target with a classification status from among: (i) unclassified; (ii) operator classified; and (iii) automated agent classified;
in response to receiving a user input confirming a classification of a particular target by the automated agent, changing the classification and the annotation of the particular target from automated agent classified to operator classified; and
in response to receiving a user input overruling a classification of the particular target by the automated agent, changing the classification and the annotation of the particular target from automated agent classified to unclassified.

3. The method of claim 2, wherein changing the classification of the particular target by the automated agent is further in response to determining that the particular target has been annotated as classified by the automated agent for more than a specified delay interval.

4. The method of claim 1, further comprising transmitting an alert containing information of the classified target to a management console that takes corrective action to mitigate the threat.

5. The method of claim 1, further comprising, in response to the amount of time that the particular target has been presented without an operator response exceeding a second time threshold that is less than the first time threshold, automatically annotating the particular target on the at least one display to prompt the operator.

6. The method of claim 1, further comprising:
tracking an inter-arrival time (IRT) of the presentation of the one or more targets; and
in response to the IRT exceeding a first rate threshold, reducing the first time threshold.

7. The method of claim 6, further comprising, in response to the IRT being less than a second rate threshold that is less than the first rate threshold, increasing the first time threshold.

8. The method of claim 1, wherein:
the assigned target area comprises a network of information handling systems;
the at least one target sensor comprises a remote agent communicatively coupled to the network information handling system to receive and report workload indications from at least one of the information handling systems;
the target comprises a workload indication that is above a threshold for a particular information handling system; and
the classification comprises designating the workload indication as one of: (i) a cyber attack; and (ii) not a cyber attack.

9. The method of claim 1, wherein:
monitoring the assigned target area using the at least one target sensor comprises receiving radar returns of an airspace sector assigned to an operator station;
tracking categorization status for targets within the assigned target area comprises at least one of aircraft detection and aircraft identification; and
presenting, on at least one display of the operator station, one or more targets being tracked by the automated controller within the assigned target area comprises presenting, on at least one display of the operator station, one or more targets based on the radar returns positioned to represent a current location within the air space sector.

10. The method of claim 9, wherein:
the operator and automated agent responses indicate detection of a particular target being an aircraft; and
the automated agent is an aircraft detection agent.

11. The method of claim 9, wherein:
the operator and automated agent responses identify a particular target as being one of a friendly aircraft and an unfriendly aircraft; and
the automated agent is an aircraft identification agent.

12. The method of claim 9, further comprising:
receiving a secondary source of data associated with the one or more targets comprising one or more of infrared data, flight plan data, and kinematic data;
presenting the secondary source of data on the at least one display of the operator station to assist the operator; and
providing the secondary source of data to the automated response agent that bases an automated response at least in part on the secondary source of data.

13. A threat monitoring system that engenders a human-automation collaborative response, the threat monitoring system comprising:
at least one target sensor that detects targets within a target area;
an operator station having an automatic controller, at least one display, and a user interface device that receives a user input from an operator, the automated controller communicatively coupled to the at least one target sensor, the at least one display, the user interface device, and which:
monitors, by an automated controller, an assigned target area using at least one target sensor;
tracks categorization status for targets within the assigned target area;
presents, on at least one display of the operator station, one or more targets being tracked by the automated controller within the assigned target area;
annotates the one or more targets on the at least one display with an indication of classification status; and
in response to a previously receiving a previously untracked target from the at least one sensor:
tracks an amount of time that each target has been presented without an operator response to each target via a user interface device; and
in response to the amount of time that a particular target has been presented without an operator response exceeding a first time threshold, automatically responds to the particular target using an automated agent.

14. The threat monitoring system of claim 13, wherein the automated controller:
annotates the one or more targets by designating each target with a classification status from among: (i) unclassified; (ii) operator classified; and (iii) automated agent classified;
in response to receiving a user input confirming a classification of a particular target by the automated agent, changes the classification and the annotation of the particular target from automated agent classified to operator classified; and
in response to receiving a user input overruling a classification of the particular target by the automated agent, changes the classification and the annotation of the particular target from automated agent classified to unclassified.

15. The method of claim 14, wherein the automated controller changes the classification of the particular target by the automated agent is further in response to determining that the particular target has been annotated as classified by the automated agent for more than a specified delay interval.

16. The threat monitoring system of claim 13, wherein the automated controller transmits an alert containing information of the classified target to a management console that takes corrective action to mitigate the threat.

17. The threat monitoring system of claim 13, wherein the automated controller, in response to the amount of time that the particular target has been presented without an operator response exceeding a second time threshold that is less than the first time threshold, automatically annotates the particular target on the at least one display to prompt the operator.

18. The threat monitoring system of claim 13, wherein the automated controller:
tracks an inter-arrival time (IRT) of the presentation of the one or more targets; and
in response to the IRT exceeding a first rate threshold, reduces the first time threshold.

19. The threat monitoring system of claim 18, wherein the automated controller, in response to the IRT being less than a second rate threshold that is less than the first rate threshold, increases the first time threshold.

20. The threat monitoring system of claim 13, wherein:
the assigned target area comprises a network of information handling systems;
the at least one target sensor comprises a remote agent communicatively coupled to the network information handling system to receive and report workload indications from at least one of the information handling systems;
the target comprises a workload indication that is above a threshold for a particular information handling system; and
the classification comprises designating the workload indication as one of: (i) a cyber attack; and (ii) not a cyber attack.

21. The threat monitoring system of claim 13, wherein the automated controller:
monitors the assigned target area using the at least one target sensor comprises receiving radar returns of an airspace sector assigned to an operator station;
tracks categorization status for targets within the assigned target area comprises at least one of aircraft detection and aircraft identification; and
presents, on at least one display of the operator station, one or more targets being tracked by the automated controller within the assigned target area by presenting, on at least one display of the operator station, one or more targets based on the radar returns positioned to represent a current location within the air space sector.

22. The threat monitoring system of claim 21, wherein:
the operator and automated agent responses indicate detection of a particular target being an aircraft; and
the automated agent is an aircraft detection agent.

23. The threat monitoring system of claim 21, wherein:
the operator and automated agent responses identify a particular target as being one of a friendly aircraft and an unfriendly aircraft; and
the automated agent is an aircraft identification agent.

24. The threat monitoring system of claim 21, further comprising:
receiving a secondary source of data associated with the one or more targets comprising one or more of infrared data, flight plan data, and kinematic data;
presenting the secondary source of data on the at least one display of the operator station to assist the operator; and
providing the secondary source of data to the automated response agent that bases an automated response at least in part on the secondary source of data.

24. A computer program product for that engenders a human-automation collaborative response, the computer program product comprising:
a computer-readable storage device having stored thereon program code that, when executed, configures a processor to perform executable operations comprising:
monitoring, by an automated controller, an assigned target area using at least one target sensor;
tracking categorization status for targets within the assigned target area;
presenting, on at least one display of the operator station, one or more targets being tracked by the automated controller within the assigned target area;
annotating the one or more targets on the at least one display with an indication of classification status; and
in response to a previously receiving a previously untracked target from the at least one sensor:
tracking an amount of time that each target has been presented without an operator response to each target via a user interface device; and
in response to the amount of time that a particular target has been presented without an operator response exceeding a first time threshold, automatically responding to the particular target using an automated agent.
